(19) United States
(12) Patent Application Publication
(10) Pub. No.: US 2009/0250398 A1
(43) Pub. Date: Oct. 8, 2009

(54) SEAWATER DESALINATION SYSTEM AND METHOD

(76) Inventor: Moshe MELLER, Tel Aviv (IL)

Correspondence Address: FRISHAUF, HOLTZ, GOODMAN & CHICK, PC, 220 Fifth Avenue, 16TH Floor, NEW YORK, NY, 10001-7708, US

(21) Appl. No.: 12/126,023

(22) Filed: May 23, 2008

Related U.S. Application Data
(60) Provisional application No. 61/042,913, filed on Apr. 7, 2008.

(51) Int. Cl. C02F 1/44; B01D 65/02

(52) U.S. Cl. 210/636; 210/170.11; 210/652

(57) ABSTRACT

Desalination system includes a submersible module defining a water-receiving interior and including openings leading from the interior to an exterior, reverse osmosis (RO) membranes arranged in each opening such that the RO membrane is exposed to seawater when the module is submersed, a pump arranged in connection with the interior of module, and a movement system for adjusting the vertical depth at which the module is submersed. The movement system can move the module in vertical and horizontal directions, in any predetermined pattern, or in vertical—horizontal planes defined by the movement system from one location to another location to prevent an elevated salt concentration in an area adjacent the RO membranes and to thereby maintain the osmotic pressure of the seawater in the area adjacent the RO membranes low.

### FIELD OF THE INVENTION

The present invention relates generally to seawater desalination systems and methods, and more particularly to seawater desalination systems and methods which use reverse osmosis to desalinate seawater.

### BACKGROUND OF THE INVENTION

The world's fresh water consumption rate is doubling every 20 years. It is projected that by the year 2025, water demand will exceed supply by about 56%. Therefore, a significant efforts are being made to desalinate seawater in order to produce drinkable fresh water. Some desalination systems use a reverse osmosis process, which is well-known in the art.

One of the most significant limitations of using existing reverse osmosis systems for desalinating seawater in order to produce drinkable fresh water is the high energy consumption and therefore high cost of operating such systems. As a result, the costs for producing fresh water by desalinating seawater are relatively high.

Seawater desalination requires a minimum energy consumption usually equal to about the osmotic pressure of the seawater times the volume of the desalinated water. This minimum theoretical energy value is derived from the laws of thermodynamics. The osmotic pressure is almost proportional to the salt concentration in the water. For seawater, the osmotic pressure is about 27 Bars, and the minimum theoretical energy is about 0.75 KWH/cubic meter of desalinated water.

Most reverse osmosis (RO) desalination systems use a basic process shown in FIG. 1, in which a high pressure pump 102 pumps seawater 101 into a module 109. The module 109 is separated by an RO membrane 104 into two parts 103 and 105. The RO membrane 104 allows water molecules to flow through but blocks the salt molecules in the seawater. The volume of water beyond the membrane, volume B in part 105, is thus desalinated. The volume B of desalinated seawater in part 105 is removed from module 109 via an outlet 106.

The salt molecules in volume A that are left behind the RO membrane 104 in part 103 increase the salt concentration in the water in volume A. As a result, there is an increase in osmotic pressure in part 103 thus requiring a higher pump pressure for continuing the desalination process. After part of the pressurized seawater (about 30%) has passed through the RO membrane 104, the rest of the seawater (about 70%) has to be released from part 103 through a valve 108 because the pump's pressure required to overcome the increased osmotic pressure in part 103 is too high for proper operation of the reverse osmosis membrane 104 (the released high salt concentration water being designated 107). The higher pump pressure required because of the increasing salt concentration in the water in volume A, and the volume of pressurized salt water which has to be released from part 103 through valve 108, are the main reasons that the practical energy required for seawater desalination is higher than about 2 KWH/cubic meter, which is much higher than the minimum theoretical energy requirement of about 0.75 KWH/cubic meter.

FIG. 2 shows a curve of the operational pressure in part 103, volume A, as a function of time. The vertical axis 201 indicates the operational pressure and the horizontal axis 207 indicates time. The maximum operational pressure in volume A is represented by 202 and the starting operational pressure in volume A is represented by 203. The osmotic pressure of the seawater, i.e., 27 Bars, is indicated by reference 204. The maximum operational pressure point is indicated by reference 205 and the minimum operational pressure point in indicated by reference 206.

In use, as seawater flows into the pump 102 and is pressurized into volume A in part 103 of the module 109, the operational pressure at the starting point 203 must be higher than the osmotic pressure of seawater 204, in order to force the water molecules through the RO membrane 104 and leave behind the salt molecules. As this happen, the salt molecules that are left behind in part 103 increase the concentration of salt in volume A and thus, increase the osmotic pressure (which is proportional to the salt concentration) in volume A. This higher osmotic pressure requires a higher operational pressure of the pump 102 in order to continue the desalination process. As the process continues, the operational pressure gradually increases (the line extending upward from the starting point 203) reaches a maximum level (first maximum 205) and at this time, the valve 108 is opened and releases the high salt concentration water 107 from part 103. This causes a sharp reduction in the operational pressure, the line from the first maximum 205 to the first minimum 206. When the operation pressure reaches point 206, the valve 108 is closed and the operational pressure rises again. This process continues to thereby provide a pressure/time curve as shown in FIG. 2.

Disadvantages of this system are that the average operational pressure is higher than the minimum operational pressure required for the process, and because the energy consumption is equal to pressure multiplied by the volume of desalinated water, the energy required for the desalination process is higher than the minimum theoretical energy. Moreover, the volume of high salt concentration water 107 which is released after been pressurized causes a waste of energy.

FIG. 3 shows another prior art system for desalinating seawater. This system uses underwater pressure, e.g., the increased pressure in deep sea regions, in order to force water molecules through an RO membrane and leave salt molecules in the seawater in front of the RO membrane. An RO desalination module 306 has an RO membrane 310 exposed to the seawater 303. A high pressure, high volume pump 307 is arranged in the module 306. A conduit or outlet hose 305 connects the pump 307 to a location above the surface 301 of the sea wherein the ambient pressure may be 1 Bar. In use, seawater 303 flows in the directions of arrows 312 toward the outer face of the RO membrane 310. The pressure differential between the seawater 303 and the pressure of the ambient atmosphere at the outlet 302 of hose 305 at or proximate the sea surface 301 causes water molecules to pass through the RO membrane 310. The thus-desalinated water 309 flows into an inlet of the pump 307 and then through the pump 307 into hose 305, and through hose in the direction of arrow 304 to the outlet 302 of the hose 305. Adjacent the outer face of the RO membrane 310, there is thus-formed high salt concentration water 311.

FIG. 4 shows a curve of the pressure differential between the area outward of the outer face of the RO membrane 310 and the area inward of the inner face of the RO membrane 310, i.e., inside the module 306, as a function of time. The vertical axis 401 indicates the pressure differential and the horizontal axis 402 indicates time. The maximum differential pressure of the system is indicated by reference 405, the minimum differential pressure of the system is indicated by reference 403 and the seawater osmotic pressure, which is 27 Bars, is indicated by reference 404. In use, the module 306 is placed in the body of seawater deeper than about 270 meters, which is a depth which will provide hydrostatic pressure greater than the minimum differential pressure 403. The pressure differential, i.e., the hydrostatic pressure minus the pressure inside the module 305 (the pressure inside the module 305 may be maintained at 1 Bar by the pump 307), forces water molecules through the RO membrane 310 while the salt molecules are left behind in the body of the seawater. These salt molecules increase the salt concentration in the water 311 alongside the outer face of the RO membrane 310, and as a result, increase the osmotic pressure that the pressure differential must overcome in order to force the water molecules through the RO membrane 310. This process of increasing the concentration of the salt in the area close to or surrounding the RO membrane 310 continues until the system reaches equilibrium at point 402. The value of salt concentration in the area close to or surrounding the RO membrane 310 at point 402 depends on the volume capacity of desalinated water that is pumping out from the system, and on the specific construction of the system. For any given system, a higher desalination water volume means a higher salt concentration in the area close to or surrounding the RO membrane 310, and therefore a higher value of point 402.

The energy required for desalinating a volume of water by this system is roughly equal to the volume of desalinated water multiplied by the value of the maximum differential pressure, indicated by point 402. This energy is significantly higher than the minimum theoretical energy, because point 402 is significantly higher than 27 Bars. The point 402 can be lower if the system will work in a low capacity mode, or will work not continuously. However, since a high volume capacity is sought, a continuously operated desalinated seawater system is desired.

### OBJECTS AND SUMMARY OF THE INVENTION

It is an object of the present invention to provide a new and improved system and method for desalinating seawater using reverse osmosis.

It is another object of the present invention to provide a new and improved system for producing drinkable fresh water from seawater which has a low energy consumption (close to a theoretical minimal thermodynamic required energy for desalinating seawater).

It is yet another object of the present invention to provide a new and improved system and method for producing drinkable fresh water from seawater that is simple and inexpensive to build and operate.

In order to achieve at least one of these objects and possibly others, a seawater desalination system in accordance with the invention includes a submersible module defining a water-receiving interior and including openings leading from the interior to an exterior, a reverse osmosis (RO) membrane arranged in each opening such that the RO membrane is exposed to seawater when the module is submersed, a pump arranged in connection with the interior of the module, and a movement system coupled to the module for adjusting the vertical depth at which the module is submersed and for moving the module in a horizontal plane. The module may be moved in any number of different directions in the horizontal plane.

The desalinated water is collected in the interior of the module and then pumped out of the module. To this end, a conduit system including one or more conduits and/or connectors, is connected to an outlet of the pump for conveying the desalinated water from the interior of the module to a remote location, site or facility at which desalinated water is collected, stored, distributed or used. The remote location may be a water container on a floating platform from which the module is suspended or a land-based storage tank.

The movement system may be arranged to continuously move the module in vertical and horizontal directions, and possibly in a predetermined pattern. In one embodiment, the movement system is arranged in a platform and includes a winch having a cable connected to the module for moving the module in a vertical direction, the module being suspended in the seawater from the cable. The platform may be floating on the sea surface, tethered to the floor of the body of water and/or fixed at a set location. The movement system also includes a horizontally movable cart on the platform and on which the winch is arranged such that horizontal movement of the cart causes horizontal movement of the winch, and one or more additional winches for moving the cart in one or more horizontal directions. The horizontal movement of the cart thereby causes horizontal movement of the module.

The module may be formed from one or more walls and arranged to withstand hydrostatic pressure of at least about 27 Bar when an interior pressure is about 1 Bar. The pump can thus be arranged to maintain pressure in the interior of the module at about 1 Bar. The pump may be arranged entirety within the module or alternatively, arranged outside of the module and then connected to the interior of the module through a pump inlet extending through one of the openings into the interior of the module.

A method for desalinating seawater in accordance with the invention includes forming a module with a water-receiving interior and one or more openings leading from the interior to an exterior, arranging a reverse osmosis (RO) membrane in each opening such that the RO membrane is exposed to seawater when the module is submersed, arranging a pump in connection with the interior of the module, coupling a conduit system to an outlet of the pump and to a remote outlet location at which desalinated water is collected, stored, distributed or used, submersing the module to a depth at which hydrostatic pressure of the seawater causes water molecules to be forced through the RO membrane into the interior of the module while salt molecules remain outward of an outer face of the RO membrane, and moving the module from one location to another location. The module movement is preferably controlled to prevent an elevated salt concentration in an area adjacent the RO membrane and thereby maintain the osmotic pressure of the seawater in the area adjacent the RO membrane low.

Movement of the module may be continuous such that the module is continually changing its location, and may have a predetermined pattern. In one embodiment, which might be realized using the structure described above, the module is moved by adjusting the vertical depth at which the module is submersed and also moving it in a horizontal plane, e.g., via winches mounted on a platform. For example, the module may be moved in a reciprocating vertical motion and/or in a reciprocating horizontal motion.

To clean each RO membrane, the pump is periodically stopped to create a situation where the hydrostatic pressure of desalinated water in the interior of the module in combination with an osmotic pressure differential between the desalinated water and seawater of the module pushes water molecules outward from the module through the RO membrane and thereby washes and cleans the RO membrane.

Other and further objects, advantages and features of the present invention will be understood by reference to the following specification in conjunction with the annexed drawings, wherein like parts have been given like numbers.

### BRIEF DESCRIPTION OF THE DRAWINGS

The invention, together with further objects and advantages thereof, may best be understood by reference to the following description taken in conjunction with the accompanying drawings, wherein like reference numerals identify like elements, and wherein:

FIG. 1 shows a prior art system for desalinating water using reverse osmosis.

FIG. 2 is a graph showing the operational pressure of an initial part of the desalination system shown in FIG. 1 before the water passes through the reverse osmosis membrane.

FIG. 3 shows another prior art system for desalinating water using reverse osmosis.

FIG. 4 is a graph showing the differential pressure between areas on opposite sides of the membrane in the desalination system shown in FIG. 3.

FIG. 5 shows a first embodiment of a system for desalinating water using reverse osmosis in accordance with the invention.

FIG. 6 is a graph showing the operational pressure of an initial part of the desalination system shown in FIG. 5 before the water passes through the reverse osmosis membrane.

FIG. 7 shows a second embodiment of a system for desalinating water using reverse osmosis in accordance with the invention.

FIG. 8 is a cross-sectional view taken along the line 8-8 of FIG. 7.

FIG. 9 shows a portion of the system shown in FIG. 7 which enables continuous motion of a main module of the desalination system through the body of seawater.

FIG. 10 shows a partly broken-away view of another embodiment of a desalination module in a system for desalinating water using reverse osmosis in accordance with the invention.

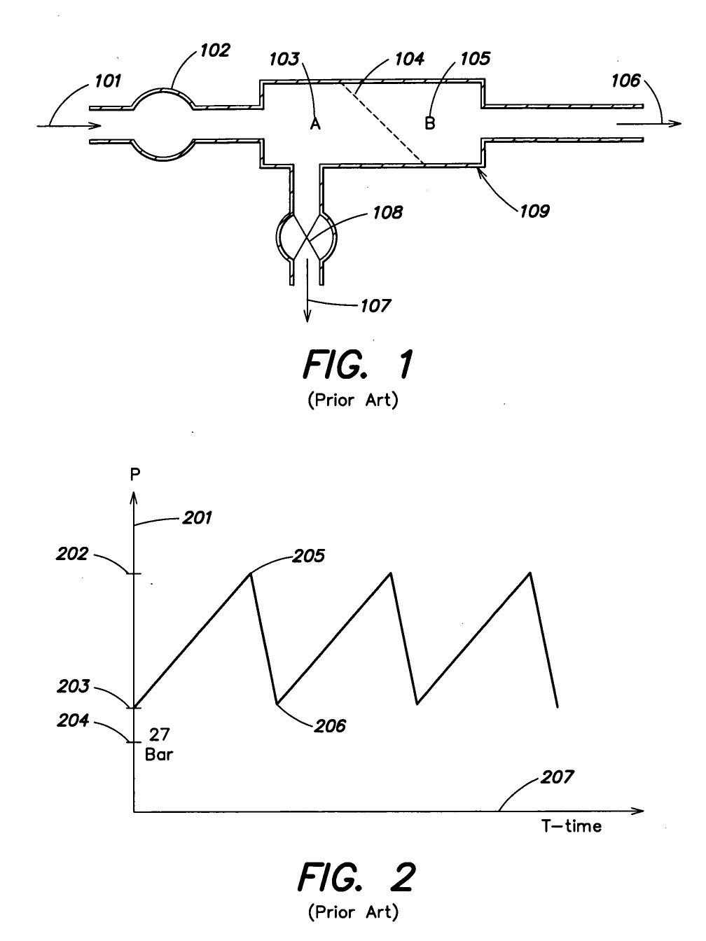

### DETAILED DESCRIPTION OF THE INVENTION

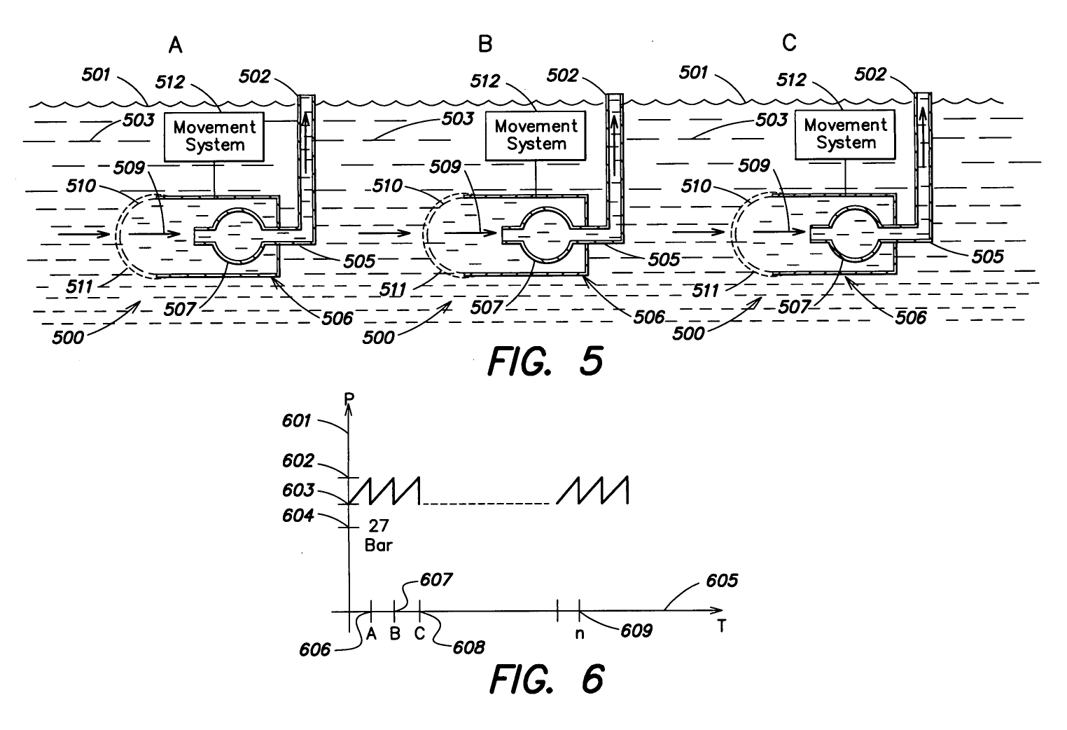

Referring to the accompanying drawings wherein like reference numerals refer to the same or similar elements, FIG. 5 shows a desalination system in accordance with the invention, which is designated generally as 500, in three alternative positions designated A, B and C relative in a body of seawater, or other body of water from which water is to be desalinated. The desalination system 500 includes an RO desalination module 506 which has an RO membrane 510 exposed to the seawater 503. The RO membrane 510 is therefore arranged in an opening between the interior of the module 506 and the exterior of the module 506. A high pressure, high volume pump 507 is arranged in the module 506, e.g., entirely within the module. A conduit system including and outlet hose 505 connects the pump 507 to a location above the surface 501 of the sea wherein the ambient pressure may be 1 Bar. Hose 505 may be flexible or partly flexible and partly rigid. The conduit system may include other hoses and connectors which cooperate to define a fluid passage from the outlet of the pump 507 to one or more locations at which the desalinated water is collected, stored, distributed or used.

In use, seawater 503 flows toward the outer face of the RO membrane 510. The pressure differential between the seawater 503 and the pressure of the ambient atmosphere at the outlet 502 of hose 505 at, proximate or above the sea surface 501 causes water molecules to pass through the RO membrane 510. The thus-desalinated water 509 flows into an inlet of the pump 507 and then through the pump 507 into hose 505. Adjacent and outward of the outer face of the membrane 510, there is high salt concentration water 511. The high salt concentration water may be at a distance of 0 (on the outer face of the RO membrane 510) to about a few millimeters from the RO membrane 510.

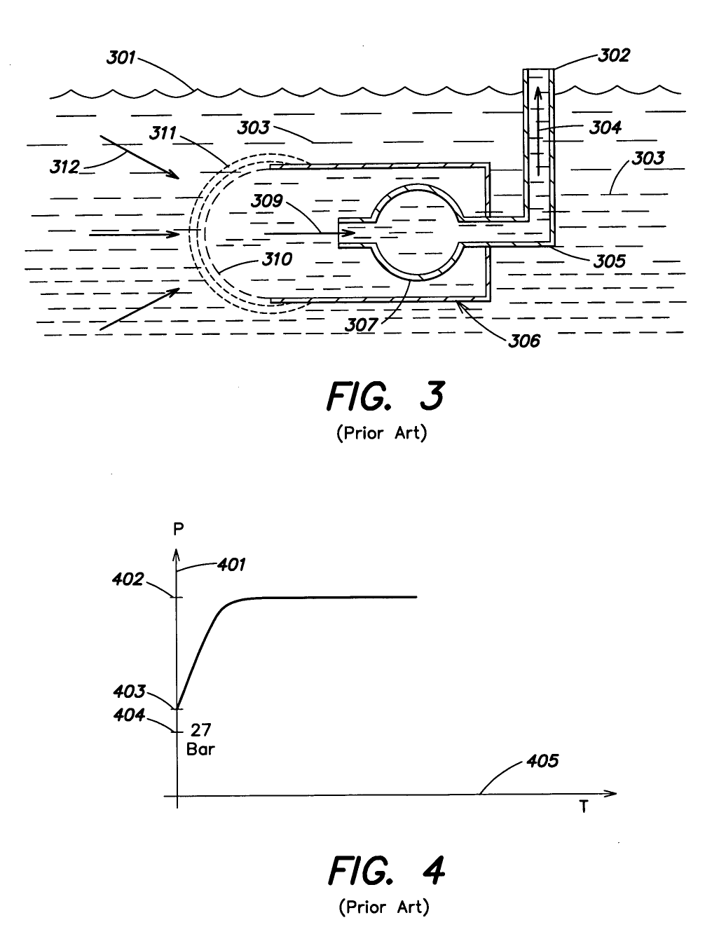

Module 506 is thus similar to module 306 described above with reference to FIG. 3. However, the desalination system 500 in accordance with the invention also includes a movement mechanism or system 512 which is coupled to the module 506 and arranged to move the module to different locations in the body of seawater, e.g., from location A to location B and from location B to location C. Movement system 512 can move the module 506 to any number of different locations in the body of seawater, and in any order between such different locations, and the three locations A, B and C shown in FIG. 5 are examples only. Movement system 512 is shown in the body of water connected to the module 509 but this is for illustration purposes only and the movement system 512 may be partly in the water, partly floating on the sea surface 501 and/or partly above the sea surface 501.

The main objective in providing movement system 512 to move the module 506 is to allow the module 506 to avoid a condition wherein the salt concentration in the seawater in the area close to the outer face of the RO membrane 510, and possibly surrounding the RO membrane 510, increases during high volume continuous desalination operation of module 506 (as occurs with module 306 described above).

FIG. 6 shows a curve of the pressure differential between the area immediately outward of the outer face of the RO membrane 510 and the area inward of the inner face of the RO membrane 510, i.e., inside the module 506, as a function of time. The vertical axis 601 indicates the pressure differential and the horizontal axis 605 indicates time. The maximum differential pressure of the system is indicated by reference 602, the minimum differential pressure of the system is indicated by reference 603 and the seawater osmotic pressure, which is 27 Bars, is indicated by reference 604. The final time at which the module 506 remains in location A is designated 606, the final time at which the module 506 remains at location B is designated 607 and the final time at which the module 506 remains at location C is designated 608. Further, the final time that the module remains at any location designated n is designated 609.

In use, the module 506 is submerged in the body of seawater 503 to a depth greater than about 270 meters, which is a depth which will provide hydrostatic pressure greater than the minimum differential pressure 603. Of course, different types of water may have different osmotic pressure and therefore all that is required is that the module 506 be submerged to a depth at which the hyrostatic pressure is greater than the minimum differential pressure required for the module 506 to function.

The pressure differential, i.e., the hydrostatic pressure minus the pressure inside the module 506, forces water molecules through the RO membrane 510 while the salt molecules are left behind in the body of the seawater. These salt molecules increase the salt concentration in the water in the area 511 alongside the outer face of the RO membrane 510, and as a result, increase the osmotic pressure that the pressure differential must overcome in order to continue to force the water molecules through the RO membrane 510. This process of increasing the concentration of the salt in the area 511 close to and immediately outward from the RO membrane 510 continues until the system reaches point 602, which is determined to be a point prior to the equilibrium point. At this time, the movement system 512 is actuated to move the module 506 to a new location, e.g., from location A to location B. As a result of this movement, there is no longer the high concentration salt water alongside the RO membrane 510 but rather there is preferably the minimum pressure differential 603. The module 506 is then operative at location B until the pressure differential approaches or reaches close to points 602 and 603, at which time the movement system 512 is again actuated to move the module 506 to location C. This process continues with periodic movement of the module 506 from a current location to a new location at which the salt concentration is less based on the pressure differential at the current location.

The time at which the module 506 is at each location, i.e., the time intervals, can be very short and vary as a function of the desalination process. As the time interval decreases, the difference between the minimum operational pressure differential 603 and the movement point 602 will be smaller. Indeed, it is conceivable that the process of moving the desalination system from one location to a new location upon actuation of the movement system 512 will be continuous thereby providing non-stop, continual movement of the module 506 through the body of seawater.

The continuous motion of the module 506 via the movement system 512 is generally horizontal and relatively slow, and therefore requires small amounts of energy. This continuous motion should not be confused with techniques which provide a washing and cleaning effect on an RO membrane. Rather, the primary or only purpose of this slow motion of the module 506 effected via the movement system 512 is to position the RO membrane 510 continuously in new locations in the body of seawater where the osmotic pressure is close to 27 Bars. Although the RO membrane 510 will inherently be washed as the module 506 moves from one location to another, this washing effect is simply a beneficial consequence.

The amplitude of the movement of the module 506 via movement system 512 can be from about 5 to about 10 meter, although this range is provided as an example only and in no way should be construed to limit the invention to any amplitude or range of amplitudes. Indeed, it is envisioned that other amplitudes and amplitude ranges can be used in accordance with the invention while still providing the benefits thereof.

The speed of the movement can be from about 0.5 meter/second to about 1 meter/second, although this range is provided as an example only and in no way should be construed to limit the invention to any speed or range of speeds. Indeed, it is envisioned that other speeds of movement and speed ranges can be used in accordance with the invention while still providing the benefits thereof. The slow motion of the RO membrane 510 at the speed of about 0.5 to about 1.0 meter/second through the body of seawater should typically require a very small amount of energy.

Since the movement system 512 can be controlled to provide that the average operational pressure differential of desalination system 500 is very close to the minimum pressure differential 603, which in turn is very close to the osmotic pressure of the seawater, 27 Bars, energy efficiency close to the theoretical minimum of 0.75 kWh/cubic meter of desalinated water can be achieved. Constant salt concentration in the area surrounding of the RO membrane 510 means constant osmotic pressure close to 27 Bars, point 604. Thus, multiplying the desalinated water volume by the constant 27 bars osmotic pressure provides an energy consumption of about 0.75 KWH/cubic meter. Factoring in some losses, a very low energy consumption per unit volume of desalinated water can still be achieved.

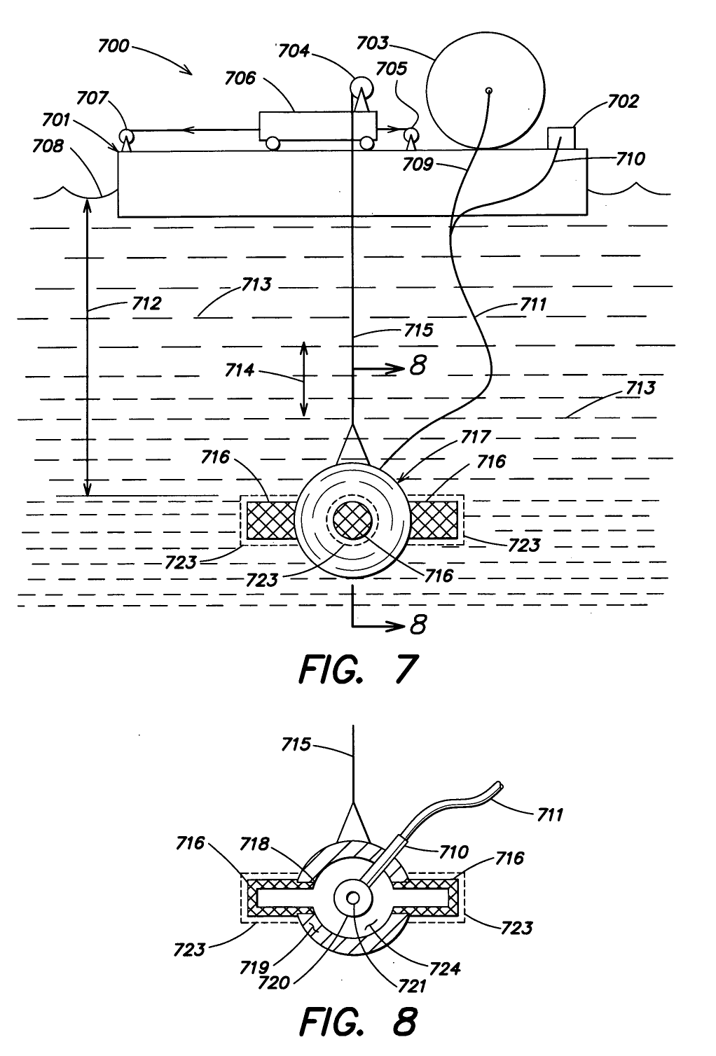

Referring now to FIGS. 7-9, a second embodiment of a desalination system in accordance with the invention is shown and is designated generally as 700. Desalination system 700 includes a substantially hollow, main desalination module 717. Main desalination module 717 preferably has a substantially spherical shape (it may be generally spherical with one or more flattened areas), but may alternatively have other shapes. Module 717 is constructed of appropriate materials to enable it to be submersible and withstand an outside pressure of more than about 27 or 30 bars, i.e., a pressure differential between the interior space 724 of the module 717 and the outside of the module 717. The materials and construction of the module 717 to enable this are readily identifiable and known to those skilled in the art to which the invention pertains. For example, the module 717 may be made of thick walls 719, possibly made from composite materials. The specific weight of the module is greater than 1 to allow gravity to lower the module in the body of water.

Module 717 has one or more openings 718, which may be passages or holes, that connect the interior 724 of the module 717 to the exterior thereof, i.e., pass through the circumferential structure, housing or walls 719 of the module 717. An RO membrane 716 is arranged in each opening 718. In the illustrated embodiment, the RO membrane 716 has a cup-shaped form having a tubular portion adjacent the module 717, with the opening of the cup communicating with a respective opening 718 of the module 717, and a base portion at a distance from the module 717 to thereby define a tubular passage therebetween. The RO membrane 716 therefore has a substantially cylindrical shape. It is however possible to use other forms and shapes of RO membranes. The formation of an RO membrane in the cup-shaped, substantially cylindrical form or other form or shape is known to those skilled in the art to which the invention pertains.

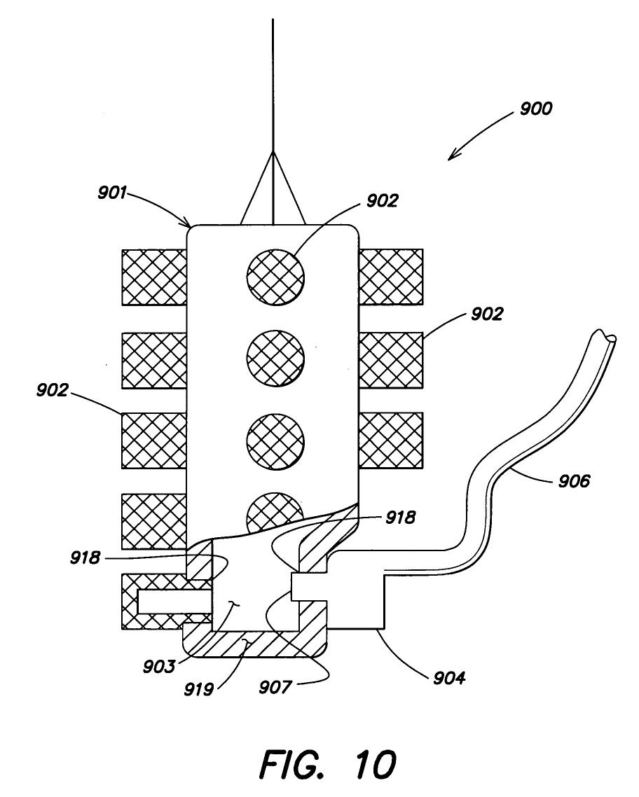

In the illustrated embodiment, there are four RO membranes 716 equally spaced around the center, horizontal plane of the module 717 such that opposite RO membranes 716 might be substantially coaxial. Any number and arrangement of RO membranes 716 may be provided (see, e.g., FIG. 10 described below).

The desalination system 700 also includes a floating platform or rig 701 which floats on the surface 708 of the body of seawater 713, a power generator 702 arranged on the rig 701, and a water container 703 which is arranged in connection with the rig 701 and used to store desalinated water produced by the module 717. Power generator 702 may be AC power generator. Also arranged on the rig 701 is a winch 704 which is arranged to wind or unwind a cable 715 connected to the module 717 around a drum thereof to thereby vertically adjust the module 717, i.e., raise and lower the module 717 to a variable depth designated 712. When winch 704 unwinds the cable 715, the force of gravity would pull the module 717 downward and thereby increase its depth. Other systems for moving the module 717 vertically are also envisioned and within the scope and spirit of the invention.

Cable 715 preferably will be made from composite materials such as carbon fiber, but other materials can be used.

The winch 704 is arranged on a movable cart 706, e.g., a base having wheels. Additional winches 705 and 707 are connected to opposite ends of the cart 706 and are controlled to provide horizontal movement of the cart 706. Specifically, when winch 705 is actuated to wind a cable on a drum thereof and thereby pull the cart 706 toward it, winch 707 is actuated to allow a cable wound thereon to unwind. When winch 707 is actuated to wind a cable on a drum thereof and thereby pull the cart 706 toward it, winch 705 is actuated to allow a cable wound thereon to unwind. In this manner, the cart 706, and thus the module 717 attached to the cable 715 of winch 704 mounted on cart 706, is provided with controlled horizontal movement. Other systems for moving the cart 706 horizontally may be used in the invention. Indeed, it is envisioned that a single winch could be used to cause bi-directional movement of the cart 706, or two winches alongside one another, with additional structure such as springs or other biasing mechanisms or pulleys.

The combination of the apparatus which cause horizontal movement and vertical movement of the module 717 constitute one embodiment of the movement system 512 generally described above.

FIG. 8 shows a high-pressure, high-volume capacity pump 720 arranged in an interior of the housing of the module 717. The pump 720 has an inlet 721 opening to the interior of the housing of the module 717, i.e., that inner volume of the module 717 in which desalinated water is presented. Pump 720 preferably has an operational pressure higher than the hydrostatic pressure of the depth 712 in which the module 717 is positioned. For example, if the depth 712 is 300 meters, the pump 720 will be designated and/or constructed such that its operational pressure is higher than about 30 Bars. The pump 720 will also be designed and/or constructed such that the volume capacity of the pump 720 is in accordance with the desalinated water capacity that is required from the system 700. A typical volumetric capacity of desalinated water that can be produced by the system 700 of the present invention is about 1000 cubic meters per hour. However, the system 700 can be designed for higher or lower volumetric capacities.

A flexible, high-pressure, high-volume hose 709 connects the pump 720 to the water container 703 on the rig 701 (see FIG. 7). The structure of an appropriate hose 709 is known to those skilled in the fluid art, and for example, may be the same type of hose that is used by fire departments. Instead of hose 709, a combination of flexible hoses, rigid hoses and/or connectors may be used to define a conduit system leading from the pump 720 to the water container 703.

An electrical cable 710 connects the power generator 702 on the rig 701 to the pump 720. It is possible to combine the hose 709 and cable 710 into a conduit assembly 711 along most or all of a portion between the module 717 and the rig 701. For example, the hose 709 may be attached or otherwise connected to the cable 710 from the module 717 to a position immediately below the rig 701 where the hose 709 separates from the cable 710 with the hose 709 leading to the container 703 and the cable 710 leading to the power generator 701 (see FIG. 7). At the module 717, the hose 709 leads to a fluid outlet of the pump 720 while the cable 710 leads to an electrical circuit of the pump 720. Hose 709 and cable 710, and any other casing or housing in which the hose 709 and cable 710 are combined, should be constructed to withstand the effects of the constant exposure to seawater, e.g., withstand the corrosive effect of the seawater.

In an exemplifying use of the system 700, the rig 701 is located over an area of the body of seawater where the depth is more than about 270 meters and the module 717 lowered into the sea to a depth 712 of more than 270 meters or more by control of the winch 704. Winch 704 is controlled to unwind the cable 715 until the desired depth of the module 717 is reached. The manner in which the unwinding of a winch 704 and the depth of the module 717 connected thereto by cable 715 are correlated is readily known to those skilled in the art. Generally, the depth 712 to which the module 717 is lowered may be any depth at which the hydrostatic pressure on the RO membrane 716 is more than 27 Bars (the osmotic pressure of seawater), although the module 717 would also be operable at other depths and minimum hydrostatic pressures. A more particular operational depth is 300 meters where the hydrostatic pressure is about 30 Bars.

The hydrostatic pressure of the seawater 713 (because of the depth) forces water molecules through the RO membrane 716 and the opening 718 into the interior of the module 717, while the salt is left behind in the area close to and outward of the RO membrane 716, i.e., adjacent or surrounding the outer face thereof. Specifically, the hydrostatic pressure of the seawater may be 27 Bars, at a depth of more than 270 meters, while the pressure in the interior of the module 717 is maintained at 1 Bar (by operation of the pump 720). This pressure differential causes the seawater to be urged toward the interior of the module 717, and since the water must pass through the RO membrane 716 in order to enter into the module 717, the seawater is forced against the RO membranes 716 causing desalination.

When desalinated water is present in the interior of the module 717, the pump 720 starts pumping the desalinated water through the flexible hose 709 toward the water container 703 on the rig 701 in an effort to maintain the pressure in the interior space 724 of the module 717 at about 1 Bar. In other words, the pump 720 is operated to maintain as high a pressure differential as possible since the pressure differential is necessary to enable continuous desalination via reverse osmosis. Pump 720 may be controlled to maintain this pressure differential substantially constant if so desired. From the water container 703, the desalinated water can be pumped or otherwise conveyed to land or elsewhere for various uses.

The salt molecules that remain outside the RO membrane 716, and against the outer face of the RO membrane 716, start to increase the salt concentration in the area 723 alongside and surrounding the RO membranes 716. This area 723 may be the area between 0 (the outer face of the RO membrane 716) and a few millimeters. The increase in the salt concentration in the area 723 will cause an increase in the osmotic pressure of the seawater therein. This higher osmotic pressure will consequently require higher pressure differential between the interior of the module 717 and the outside of the module 717 in order to continue the desalination process at the same rate and therefore require higher energy per cubic meter of desalinated water. This concept is explained above with reference to FIGS. 3 and 4.

In accordance with the invention however, to compensate for the increase in the salt concentration in area 723, the module 717 is moved to another location having a lower salt concentration. This movement of the module 717 and thus the RO membrane 716 from a location having a high salt concentration to a location having a lower salt concentration (fresh seawater) thereby enables the module 717 to continually operate at locations at which the osmotic pressure of the seawater is essentially the same. That is, the module 717 will start from the minimal operating pressure at each new location. The movement of the module 717 may be periodic, i.e., at set time intervals, or continuous.

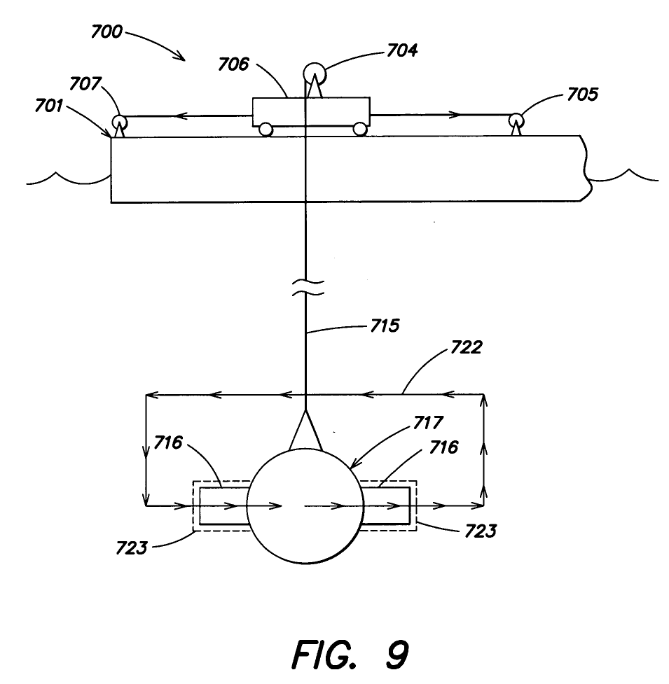

As to the manner in which the module 717 is moved, a controller or processor (not shown) is coupled to the winches 704, 705 and 707 and may include one or more user interfaces for programming the operation of the winches 704, 705, 707. FIG. 9 shows one possible path 722 of movement of the module 717 indicated by arrows. From the position shown in FIG. 9, the operation of the winches 705, 707 is controlled to cause the rightward movement of the module 717, i.e., winch 705 pulls the cable connecting it to the cart 706 while winch 707 unwinds the cable connecting it to the cart 706 or allows for unwinding of that cable. Winch 704 is not operated at this time. Thereafter, winch 704 is operated to pull cable 715, i.e. cause a portion of the cable 715 to be wound up, thereby causing the module 717 to be raised a distance upward. During this operation of winch 704, winches 705, 707 are not operating. Thereafter, the operation of the winches 705, 707 is controlled to cause the leftward movement of the module 717, i.e., winch 707 pulls the cable connecting it to the cart 706 while winch 705 unwinds the cable connecting it to the cart 706 or allows for unwinding of that cable. Winch 704 is not operated at this time. Thereafter, winch 704 is operated to cause a portion of the cable 715 to be unwound therefrom, thereby enabling the module 717 to be lowered, e.g., by the effect of gravity. During this operation of winch 704, winches 705, 707 are not operating. Thereafter, the operation of the winches 705, 707 is controlled to cause the rightward movement of the module 717, i.e., winch 705 pulls the cable connecting it to the cart 706 while winch 707 unwinds the cable connecting it to the cart 706 or allows for unwinding of that cable. Winch 704 is not operated at this time. The module 706 has therefore returned to its original location; however, during the movement, the salt concentration at the original location has been lowered to a normal concentration by natural laws of entropy. Although the example describes alternative use of winch 704 to cause or enable vertical movement of the module 717 and winches 705, 707 to cause horizontal movement of the module 717, winches 704, 705, 707 could be operational simultaneously to cause both vertical and horizontal movement of the module 717. The movement of the module may be in a pattern or in an arbitrary, non-pattern-like manner.

In a preferred embodiment, the winches 704, 705, 707 are operated to continuously change the location of the module 717. By continuously changing the location of the module 717, and thus the location at which the RO membranes 716 are situated, the salt concentration in the area around the RO membranes 716 remains low, effectively almost the same as the salt concentration in the entire body of seawater. The osmotic pressure in this area is thus also low and very close to 27 Bars (or whatever the osmotic pressure is of the water in the body of water in which the module 717 is situated).

As noted above, the movement of the module 717 is primarily to optimize the working conditions of the RO membranes 716 by enabling the area outside of the RO membranes 716 to be free from elevated salt concentrations arising from the reverse osmosis desalination process. Some cleaning of the RO membranes 716 may also occur. Nevertheless, it is still necessary to actively clean the RO membranes 716. To this end, periodically, e.g., for a few seconds every few hours or whenever required by the RO membrane specifications, the pump 720 will shut down so that the hydrostatic pressure of the desalinated water in the interior space 724 (about 27-30 Bars depending on the operating depth of the module 717), will act from the inside of the module 717 on the inner face of the RO membranes 716. This hydrostatic pressure in combination with the osmotic pressure differential will push the water molecules through the RO membrane 716 (from inside outward) and thereby wash the RO membrane 716. This operation is optional. After a short time of washing the RO membranes 716, the pump 720 will resume operation and the desalination process will continue as described above.

FIG. 10 shows another desalination system 900 in accordance with the present invention. Desalination system 900 includes a submersible desalination module 901 having a substantially cylindrical shape with a base and top wall defining an interior space 903 therebetween. Desalination module 901 is constructed of appropriate materials to enable it to withstand an outside pressure when submersed of more than about 27 or 30 bars, i.e., a pressure differential between the interior space 903 of the module 901 and the outside of the module 901. The materials and construction of the module 901 to enable this would be readily identifiable and known to those skilled in the art to which the invention pertains. The module 901 may be made of thick walls 919, possibly made from composite materials, to provide this ability.

Module 901 has a plurality of openings 918, which may be passages or holes, that connect the interior 903 of the module 901 to the exterior thereof, i.e., pass through the circumferential structure, housing or walls 919 of the module 901. An RO membrane 902 is arranged in all but one of the openings 918. Each RO membrane 902 has basically the same shape as RO membrane 716 in the embodiment shown in FIGS. 7-9. In the illustrated embodiment, there are RO membranes 902 spaced around the center axis of the module 901 at different levels.

A pump 904 is arranged at least partly or entirely outside of the walls 919 of the module 901 and has an inlet 907 passing through an opening 918 in the lowest level of openings 918 into communication with the interior 903. Alternatively, inlet 907 may be arranged in any of the other openings 918. Pump 904 may have the same construction as pump 720 described above and its outlet is connected to a flexible hose 906 of a conduit system. In this embodiment therefore, the pump is not arranged inside the walls of the module but exterior thereto, yet still in communication with the interior in which the desalinated water is accumulated.

In other respects, system 900 is the same as system 700, e.g., in the manner in which the module 901 is attached to a winch mounted on a movable cart and both vertical and horizontal movement of the module 901 effected. Also, the operation of system 900 is substantially the same as the operation of system 700 described above.

Advantages of system 900 over the system 700 includes the presence of more RO membranes leading to a common interior space in which desalinated water is accumulated. Also, module 901 may be easier and cheaper to build than the module 717 having the spherical configuration as shown in FIGS. 7-9.

It is to be understood that the present invention is not limited to the embodiments described above, but include any and all embodiments with in the scope of the following claims. While the invention has been described above with respect to specific apparatus and specific implementations, it should be clear that various modifications and alterations can be made, and various features of one embodiment can be included in other embodiments, within the scope of the present invention.

1. A water desalination system, comprising:
a submersible module submersible in a body of water from which desalinated water is to be produced, said submersible module defining a water-receiving interior and including at least one opening leading out from said interior to an exterior;
at least one reverse osmosis (RO) membrane associated with each of said at least one opening such that said at least one RO membrane is exposed to water when said module is submersed in the body of water at a depth at which hydrostatic pressure of the water causes water molecules to be forced through said at least one RO membrane into said interior of said module;
a pump arranged in communication with said interior of said module and pumping desalinated water out from said interior of said module while said module is submersed and to thereby keep the interior pressure of said module at about 1 bar; and
a moving device coupled to said module and arranged to move said module and thus said at least one RO membrane while submersed in the body of water and relative to the body of water to thereby change a location at which said module is submersed in the body of water from which water is to be desalinated to thereby keep the salt concentration adjacent to said at least one RO membrane of said module close to a salt concentration level of the body of water.

2. The system of claim 1, further comprising a conduit system connected to an outlet of said pump for conveying desalinated water from said interior of said module when said module is submersed to a remote location at which desalinated water is collected, distributed, stored or used.

3. The system of claim 1, wherein said module is formed from at least one wall and is arranged to withstand hydrostatic pressure of at more than 27 bar when an interior pressure in said module is about 1 Bar, said pump being arranged to maintain pressure in said interior of said module at about 1 Bar.

4. The system of claim 1, wherein said pump is arranged entirely within said module.

5. The system of claim 1, wherein said pump is arranged outside of said module, said at least one opening comprising a plurality of openings, and further comprising a pump inlet extending through one of said plurality of openings and thereby connecting said pump to said interior of said module.

6. The system of claim 1, wherein said moving device is arranged to continuously move said module in at least one of vertical and horizontal directions relative to the body of water.

7. The system of claim 1, further comprising a floating platform, and said moving device comprising a vertical movement mechanism having a cable connected to said module for enabling movement of said module in opposite vertical directions, a horizontally movable member on which said vertical movement mechanism is arranged such that movement of said member causes movement of said vertical movement mechanism, and a horizontal movement mechanism for moving said member in at least one horizontal direction, whereby the horizontal movement of said member provides horizontal movement of said module, said horizontal movement mechanism being arranged on said platform.

8. The system of claim 7, wherein said vertical movement mechanism comprises a winch having a cable connected to said module, said winch being arranged to rotate in one direction to cause said cable to wind around a drum thereof and in an opposite direction to allow said cable to unwind as gravity pulls said module downward.

9. The system of claim 1, wherein said at least one RO membrane has a substantially cylindrical shape.

10. The system of claim 1, wherein said module has one of a substantially spherical shape and a substantially cylindrical shape.

11. A method for desalinating water, comprising:
forming a module with a water-receiving interior and at least one opening leading out from the interior to an exterior;
associating at least one reverse osmosis (RO) membrane with each of the at least one opening such that the at least one RO membrane is exposed to water when the module is submersed in the body of water from which desalinated water is to be produced;
submersing the module in the body of water such that the at least one RO membrane is submersed to a depth at which hydrostatic pressure of the water causes water molecules to be forced through the at least one RO membrane into the interior of the module while salt molecules remain alongside an outer face of the at least one RO membrane thereby providing desalinated water in the interior of the module;
pumping the desalinated water from the interior of the module while the module and thus the at least one RO membrane is submersed in the body of water via a pump arranged in communication with the interior of the module containing the desalinated water; and
moving the module and thus the at least one RO membrane from one location to another location while maintaining the module and the at least one RO membrane submersed in the body of water and relative to the body of water to thereby keep the salt concentration adjacent to the at least one RO membrane close to a salt concentration level of the body of water to prevent an elevated salt concentration in an area adjacent to the at least one RO membrane.

12. The method of claim 11, wherein the module is submersed to a depth of at least about 270 meters, and further comprising controlling the pump to maintain the pressure in the interior of the module at about 1 Bar.

13. The method of claim 11, wherein the step of moving the module comprises continuously moving the module and thus the at least one RO membrane relative to the body of water such that the module and the at least one RO membrane are continually changing their location in the body of water.

14. The method of claim 11, wherein the step of moving the module comprises adjusting at least the vertical depth at which the module is submersed and moving the module in at least one horizontal direction relative to the body of water.

15. The method of claim 11, wherein the step of moving the module comprises at least one of moving the module in a reciprocating vertical motion and moving the module in a reciprocating horizontal motion.

16. The method of claim 11, further comprising periodically stopping the pump to create a situation where the hydrostatic pressure of desalinated water in the interior of the module in combination with an osmotic pressure differential between the desalinated water and water in the body of water push water molecules outward from the module through the at least one RO membrane and thereby clean the at least one RO membrane.

17. The system of claim 1, wherein said moving device is controlled to move said module and thus said at least one RO membrane as a function of a pressure differential between an area outward of an outer face of said at least one RO membrane and an area inward of said outer face of said at least one RO membrane.

18. The system of claim 1, wherein said at least one opening comprises a plurality of openings, said module includes at least one wall defining said plurality of openings, each of said openings leading out from said interior to an exterior through said at least one wall, said at least one RO membrane comprising a plurality of RO membranes, each associated with one of said openings, said RO membranes being arranged to extend a distance outward from said at least one wall into the body of water and thereby define a passage extending at least through said at least one wall and through which desalinated water passes into said interior of said module.

19. The system of claim 18, wherein each of said RO membranes has a substantially cylindrical shape extending outward from said at least one wall such that said passage is tubular and has a portion entirely outward of said at least one wall.

20. The system of claim 1, wherein said moving device is arranged to continuously move said module relative to the body of water.

21. The method of claim 11, further comprising controlling the movement of the module and thus the at least one RO membrane as a function of a pressure differential between an area outward of an outer face of the at least one RO membrane and an area inward of the outer face of the at least one RO membrane.

22. The method of claim 11, wherein the step of moving the module comprises continuously moving said module relative to the body of water.
